(19) United States
(12) Patent Application Publication
(10) Pub. No.: US 2024/0303008 A1
(43) Pub. Date: Sep. 12, 2024

(54) NON-TRANSITORY COMPUTER READABLE MEDIUM STORING PROGRAM

(71) Applicant: FUJIFILM BUSINESS INNOVATION CORP., Tokyo (JP)

(72) Inventor: Maki TAGUCHI, Kanagawa (JP)

(73) Assignee: FUJIFILM BUSINESS INNOVATION CORP., Tokyo (JP)

(21) Appl. No.: 18/450,788

(22) Filed: Aug. 16, 2023

(30) Foreign Application Priority Data
Mar. 8, 2023 (JP) 2023-035799

(51) Int. Cl. G06F 3/12

(52) U.S. Cl. CPC G06F 3/1205; G06F 3/1204; G06F 3/1237; G06F 3/1285

(57) ABSTRACT

A non-transitory computer readable medium storing a program causing a processor to execute a process includes distinguishing a user's account among plural accounts, and outputting after determining whether or not to print a document based on a result of the distinguishment and positional information obtained in a case where the user instructs printing.

### CROSS-REFERENCE TO RELATED APPLICATIONS

This application is based on and claims priority under 35 USC 119 from Japanese Patent Application No. 2023-035799 filed Mar. 8, 2023.

### BACKGROUND

### (i) Technical Field

The present invention relates to a non-transitory computer readable medium storing a program.

### (ii) Related Art

In the related art, there is a case where one terminal device is used for a plurality of accounts, for example, both a business use account and a private use account.

JP2021-060732A discloses an account management system that determines an account to be used according to data to be processed in a case where one user uses a device that can be used with a plurality of accounts. The system includes a data acquisition unit that acquires data to be processed based on an instruction of a user, a keyword acquisition unit that acquires a predetermined keyword from the acquired data, and an account selection unit that selects, among a plurality of accounts which can be used by the user to execute a process, an account associated with the acquired keyword as an account used to execute for data processing.

Further, JP2018-207344A discloses an image processing system capable of smoothly executing a service by charging an organization such as a company to which a user certainly belongs in a case of being used by a legitimate user for a business purpose. The system includes an image forming device that outputs an image according to an instruction from an authenticated user, and a determination device that determines whether or not an image to be output is for business use and outputs a determination result before outputting an image by the image forming device, in which the image forming device outputs an image in a case where the determination device determines that the image is for business use, and charges the organization to which the user belongs.

### SUMMARY

In a case where printing instruction for a document is given from a terminal device, it is necessary for a user to designate whether a business use account or a private use account in order to perform printing fee payment or the like, and it is troublesome to check which account is set for the terminal device each time.

Aspects of non-limiting embodiments of the present disclosure relate to a non-transitory computer readable medium storing a program that is capable of appropriately printing a document without having to check a current account each time in a case where a plurality of accounts, such as a business use account and a private use account, may be used.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a non-transitory computer readable medium storing a program causing a processor to execute a process including: distinguishing a user's account among a plurality of accounts; and outputting after determining whether or not to print a document based on a result of the distinguishment and positional information obtained in a case where the user instructs printing.

### BRIEF DESCRIPTION OF THE DRAWINGS

Exemplary embodiment(s) of the present invention will be described in detail based on the following figures, wherein:

FIG. 1 is a configuration diagram of an overall system of an exemplary embodiment;

FIG. 2 is a block diagram of a configuration of a terminal device of the exemplary embodiment;

FIG. 3 is an explanatory diagram showing a determination process of the exemplary embodiment;

FIG. 4 is a processing flowchart of the exemplary embodiment;

FIG. 5A is a display form explanatory diagram (part 1) of the exemplary embodiment;

FIG. 5B is a display form explanatory diagram (part 2) of the exemplary embodiment;

FIG. 5C is a display form explanatory diagram (part 3) of the exemplary embodiment;

FIG. 6 is a flowchart of determining whether or not to perform business use printing of the exemplary embodiment;

FIG. 7 is an explanatory diagram of positional information of the exemplary embodiment;

FIG. 8 is an explanatory diagram of time information of the exemplary embodiment;

FIG. 9 is a flowchart of determining whether or not to perform another business use printing of the exemplary embodiment;

FIG. 10 is a flowchart of determining whether or not to perform still another business use printing of the exemplary embodiment;

FIG. 11 is a flowchart of determining whether or not to perform still another business use printing of the exemplary embodiment;

FIG. 12 is a flowchart of determining a business use document of the exemplary embodiment; and

FIG. 13 is a flowchart of determining another business use document of the exemplary embodiment.

### DETAILED DESCRIPTION

Hereinafter, exemplary embodiments of the present invention will be described with reference to the accompanying drawings.

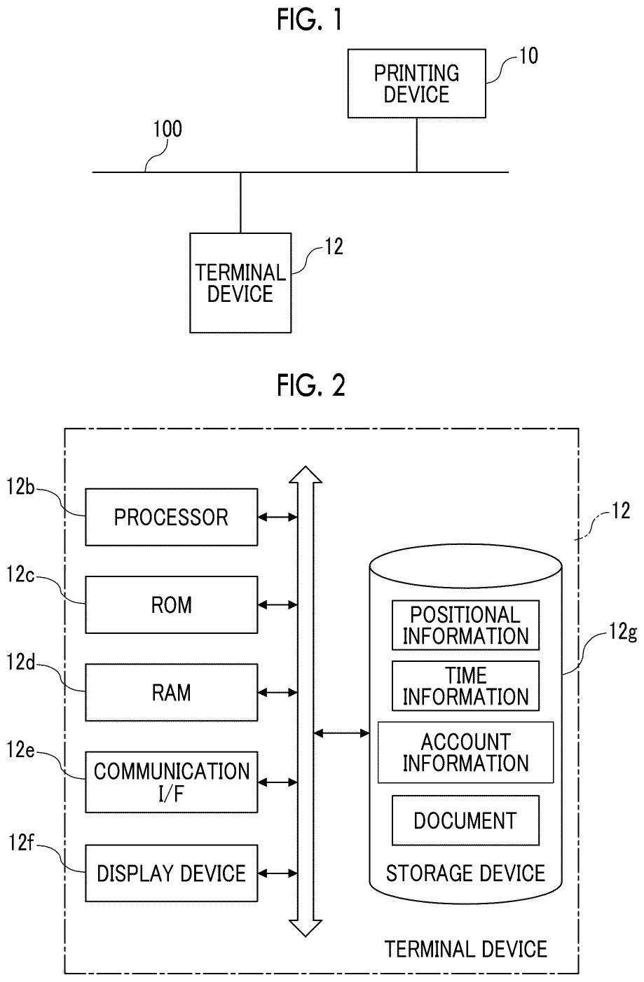

FIG. 1 is a configuration diagram of an overall system of an exemplary embodiment. A printing device 10 and a terminal device 12 are connected to each other via a network 100.

The printing device 10 receives a printing instruction (print job) from the terminal device 12, and prints and outputs a document (document file) designated by a user who operates the terminal device 12. The “document” in the present exemplary embodiment may include not only text but also an image. Although the configuration of the printing device 10 is known, a brief description will be performed below.

The printing device 10 prints an image on a printing medium, such as paper, based on a print job acquired from the terminal device 12. Here, the print job is a processing unit of a printing operation instructed by one printing instruction.

The printing device 10 includes an accommodation unit, a transport unit, a discharge unit, and a control unit, in addition to an image formation unit. The accommodation unit has a function of accommodating paper supplied to the image formation unit, and is configured by an accommodation tray on which paper is loaded.

The transport unit has a function of transporting paper accommodated in the accommodation unit to the image formation unit. The transport unit is configured by, for example, a delivery roller for delivering paper from the accommodation unit and a plurality of transport roller pairs disposed along a transport path from the accommodation unit to the image formation unit.

The image formation unit has a function of printing an image on paper. The image formation unit prints an image on paper by, for example, an electrophotographic method. That is, the image formation unit prints an image on paper through each of steps of charging, exposure, development, transfer, and fixing. In addition, the image formation unit has a function of inverting and transporting paper, and printing images on both front and back surfaces of paper.

The discharge unit is a part from which the printed paper is discharged. The discharge unit is configured by, for example, a plurality of portions disposed vertically, and the paper is discharged to a portion designated in a print job.

The control unit controls the operation of each unit of the printing device 10 based on the received print job. In a case where a plurality of print jobs are received, the control unit controls the order of each of the print jobs by a spooler.

The printing device 10 may be a multifunction machine having a plurality of functions such as a printer function, a FAX function, a copy function, and a scanning function.

Further, the printing device 10 may execute the printing process by receiving the print job from a print server (not shown) connected to the network 100.

The terminal device 12 gives a printing instruction to the printing device 10 via the network 100 in response to a user operation. The printing instruction includes a document file selected by the user by operating the terminal device 12. The terminal device 12 has a configuration in which the user can separately operate a plurality of accounts. For example, the plurality of accounts include various accounts such as a business use account, a private use account, a major business use account, and a sub business use account. In the present exemplary embodiment, a business use account and a private use account are illustrated as examples of the plurality of accounts, but the exemplary embodiment is not necessarily limited to the accounts.

In a case where a printing instruction is given from the terminal device 12 to the printing device 10, it is necessary for the user to designate a business use account or a private use account in order to perform printing fee payment or the like, and it is troublesome to check which account is set each time printing is performed. In addition, a business use document is prohibited from being printed outside a company in many cases and a private use document is prohibited from being printed inside a company in many cases, so that it is necessary to set up an appropriate account according to the type of a document to be printed, so that it is troublesome to check which account is set and to switch settings each time when printing is performed, and it is conceivable that printing is performed with an incorrect account as in a case where a private use document is printed using a business use account.

Therefore, in the present exemplary embodiment, the processor of the terminal device 12 distinguishes an account type currently set in the terminal device 12, determines whether or not to print a document using at least any of a result of the distinguishment, the positional information, the time information, and the network connection information at a current state of the terminal device 12, that is, a current time at which the printing instruction is given, and outputs a determination result.

Specifically, the processor of the terminal device 12 distinguishes whether the account set in the terminal device 12 is a business use account or a private use account, and permits printing of the business use document in a case where the account is the business use account and the current positional information of the terminal device 12 is a position where business use printing is possible. Even in a case of the business use account, printing of the business use document is not permitted in a case where the current positional information of the terminal device 12 is a position where business use printing is not possible. Further, in a case of the private use account, printing of the private use document is permitted in a case where the current positional information of the terminal device 12 is a position where private use printing is possible. Even in the case of the private use account, printing of the private use document is not permitted in a case where the current positional information of the terminal device 12 is a position where private use printing is not possible.

The network 100 may be wired or wireless and public or dedicated. An example of the network 100 is an in-house LAN (intranet) or the Internet, but is not limited thereto.

FIG. 2 shows a block diagram of a configuration of the terminal device 12.

The terminal device 12 is configured by a personal computer, a tablet terminal, a smartphone, or the like, and includes one or more processors 12b, a ROM 12c, a RAM 12d, a communication interface (I/F) 12e, a display device 12f, and a storage device 12g.

One or more processors 12b realize various functions by reading a program stored in the ROM 12c or the storage device 12g and using the RAM 12d as a working memory. The processor 12b distinguishes the account type set in the terminal device 12. In addition, the processor 12b acquires the current positional information, the time information, or the network connection information of the terminal device 12, and determines whether or not to print the document. The processor 12b outputs the result of the determination of whether or not to print the document to the display device 12f. The display form on the display device 12f is random, but, in the present exemplary embodiment, the processor 12b outputs a printable document list to the display device 12f.

The communication I/F 12e supplies a printing instruction including a document file to the printing device 10.

The display device 12f is configured by a display such as a CRT, a liquid crystal, or an organic EL, and displays a printable document list in accordance with a display control signal from the processor 12b.

The storage device 12g is configured by a non-volatile memory such as a hard disk drive (HDD) or a solid state drive (SSD). The storage device 12g stores positional information registered in advance, time information registered in advance, account information, a document file, and the like, in addition to storing the program. The positional information registered in advance defines the printable positional information of the business use document. In addition, the time information registered in advance defines the printable time information of the business use document. The account information defines the account type that is currently set among a plurality of accounts.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

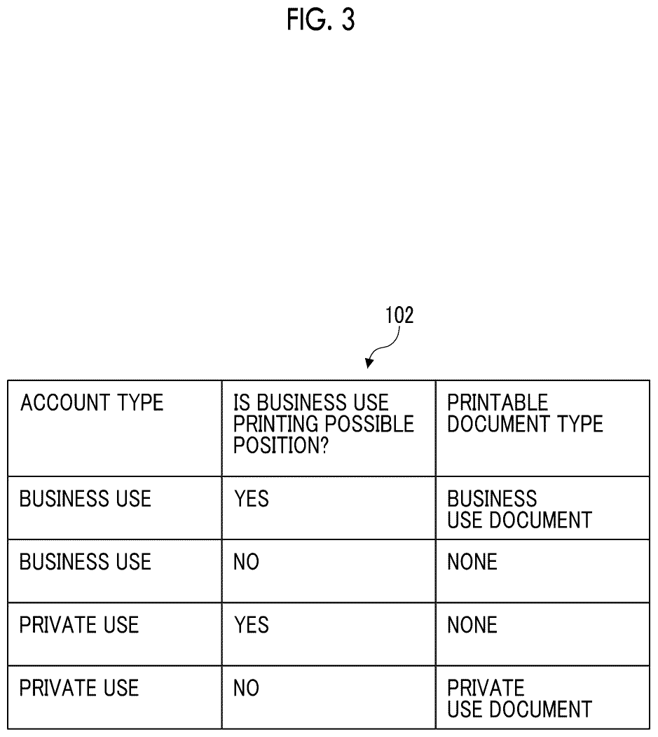

FIG. 3 shows an example of the determination process executed by the processor 12b of the terminal device 12 as a table 102. The processor 12b determines a printable document type based on the current account type and the positional information of the terminal device 12.

That is, in a case where the account type is for business use and it is the business use printing possible position (YES), the processor 12b determines that the business use document is the printable document type. In addition, in a case where the account type is for business use but it is not the business use printing possible position (NO), it is determined that there is no printable document. In a case where the account type is for private use and the position is the business use printing possible position, it is determined that there is no printable document. In a case where the account type is for private use and the position is not the business use printing possible position, the private use document is determined as the printable document type.

In a case where a business use document is determined as the printable document type, the processor 12b extracts only the business use document from the documents stored in the storage device 12g and outputs the business use document to the display device 12f. In a case where a private use document is determined as the printable document type, the processor 12b extracts only the private use document from the documents stored in the storage device 12g and outputs the private use document to the display device 12f. Whether the document is for business use or for private use may be distinguished by using a known technique. For example, in a case where a document includes a company name, a logo, or the like, the document is distinguished as the business use document, and, otherwise, the document is distinguished as the private use document. For a document which is difficult to distinguish whether the business use document or the private use document, the document may be distinguished as the private use document by default. The reason for this is to ensure the security of the business use document. Of course, the document may be presented to the user to make the user to perform a selection.

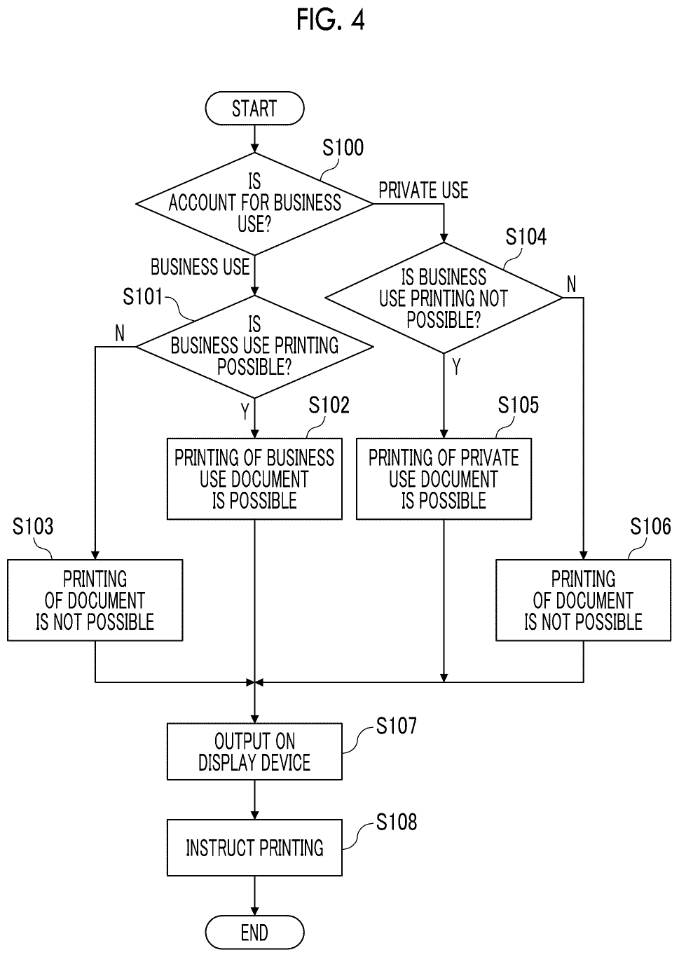

FIG. 4 shows a processing flowchart of the processor 12b of the terminal device 12.

The processor 12b starts a process at a predetermined timing, for example, a timing at which a printing instruction is received from the user. First, the processor 12b determines whether or not a currently set account among a plurality of accounts is for business use (S100). The account type is distinguished by using the account information registered in advance. The account information is account identification information (ID), an account name, an account type, or the like. The account type includes business use and private use. The processor 12b determines whether the currently set account is for business use or for private use by referring to the account type of the currently set account name or the account ID.

In a case where the account is for business use, next, it is determined whether or not it is the environment in which the business use printing is possible (S101). Whether or not it is the environment in which the business use printing is possible is specifically determined by using at least any of the positional information, the time information, and the network connection information. Then, in a case of the environment in which the business use printing is possible (YES in S101), it is determined that printing of the business use document is possible (S102). Further, unless the environment in which the business use printing is possible (NO in S101), it is determined that printing of the document is not possible (S103).

On the other hand, in a case where the account is for private use, next, it is determined whether or not it is an environment in which the business use printing is not possible (S104). In other words, the environment in which the business use printing is not possible is an environment in which the private use printing is possible, and, specifically, is determined using at least any of the positional information, the time information, and the network connection information. Then, in a case of the environment in which the business use printing is not possible (YES in S104), it is determined that printing of the private use document is possible (S105). Further, unless the environment in which the business use printing is not possible (NO in S104), it is determined that printing of the document is not possible (S106).

After determining whether or not to print the document as described above, the processor 12b outputs a printable document to the display device 12f (S107). That is, in a case where printing of the business use document is possible (S102), a list of business use documents is output to the display device 12f, and, in a case where printing of the private use document is possible (S105), a list of private use documents is output to the display device 12f.

The user selects a proper document and gives a printing instruction to the printing device 10 while visually recognizing the list of business use documents or private use documents displayed on the display device 12f (S108).

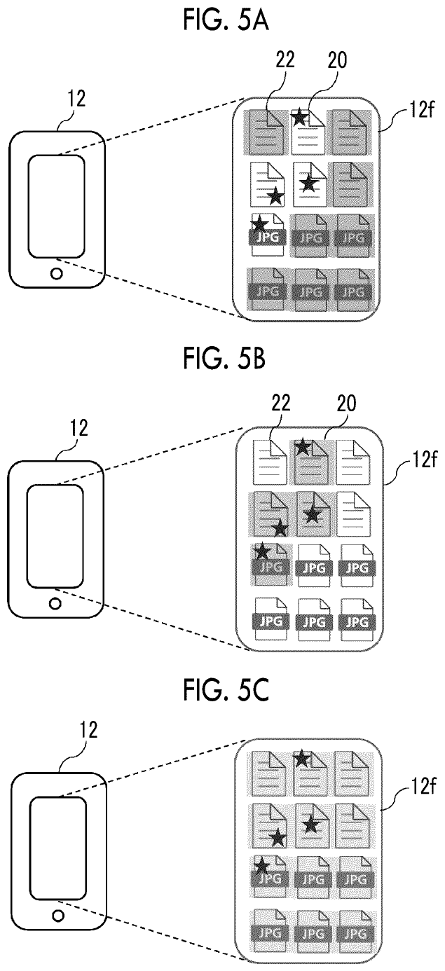

FIGS. 5A to 5C show examples of a display form of a document output to the display device 12f of the terminal device 12 by the processor 12b as an enlarged view of the display device 12f.

FIG. 5A is a display form in a case where the account is for business use and it is the environment in which the business use printing is possible. In a case where a business use document 20 and a private use document 22 are mixed as a document (including an image), the business use document 20 is extracted and displayed, and the private use document 22 is displayed in a non-selectable form as gray display. In the drawing, the star mark indicates that a company name or a logo is included. By visually recognizing the display form of FIG. 5A, the user can easily understand that the business use document 20 is selectable and printable, and the private use document 22 is non-selectable and non-printable. The user may select and print a proper business use document on the printing device 10 without being particularly aware of whether the current account setting is for business use or private use.

By visually recognizing the display form of FIG. 5A, the user can understand any of an environment in which the current account is set for private use or an environment in which business use printing is not possible even though the current account is set for business use.

FIG. 5B is a display form in a case of an environment in which the account is for private use and business use printing is not possible. In a case where a business use document 20 and a private use document 22 are mixed as a document (including an image), the private use document 22 is extracted and displayed, and the business use document 20 is displayed in a non-selectable form as gray display. In the drawing, the star mark indicates that a company name or a logo is included. By visually recognizing the display form of FIG. 5B, the user can easily understand that the private use document 22 is selectable and printable, and the business use document 20 is non-selectable and non-printable. The user may select and print a proper private use document and on the printing device 10 without being particularly aware of whether the current account setting is for business use or private use.

FIG. 5C is a display form in a case where the account is for business use and it is the environment in which the business use printing is not possible. In a case where the business use document 20 and the private use document 22 are mixed as the document (including an image), both the business use document 20 and the private use document 22 are displayed in a non-selectable form as gray display. In the drawing, the star mark indicates that a company name or a logo is included. By visually recognizing the display form of FIG. 5C, the user can easily understand that there is no printable document. In addition, the user can understand that, even in a case where the user wants to print a business use document, printing is not possible with the current account or environment, and it is necessary to switch and set the current account or change the current environment (a position, time, or a network connection state).

Specifically, in a case where the current account of the terminal device 12 is for business use and the terminal device 12 is located in the company, the business use document 20 is displayed as shown in FIG. 5A and the private use document 22 is displayed as gray display, so that the printing instruction of the business use document 20 becomes possible. Further, in a case where the current account of the terminal device 12 is for private use and the terminal device 12 is located at home of the user, the private use document 22 is displayed as shown in FIG. 5B and the business use document 20 is displayed as gray display, so that the printing instruction of the private use document 22 becomes possible. Further, in a case where the current account of the terminal device 12 is for business use and the terminal device 12 is located at home of the user, all the documents are displayed as gray as shown in FIG. 5C, so that the printing of any of the business use document 20 and the private use document is not possible.

In FIG. 5C, all the documents stored in the storage device 12g are displayed to be non-selectable as gray display. Meanwhile, the gray display is an example, and a fact that printing is not possible may be displayed to be recognizable using the color, the shape, the line type or the like of the symbolic figure (icon) of the document. In addition, a message may be displayed instead of displaying the icon of the document. For example, a message such as
“There is no printable document.
Please check your current account and environment.”
may be displayed. Alternatively, a message such as
“There is no printable document.
The current account is for business use but the environment is not appropriate.”
may be displayed to prompt the user to change the environment.

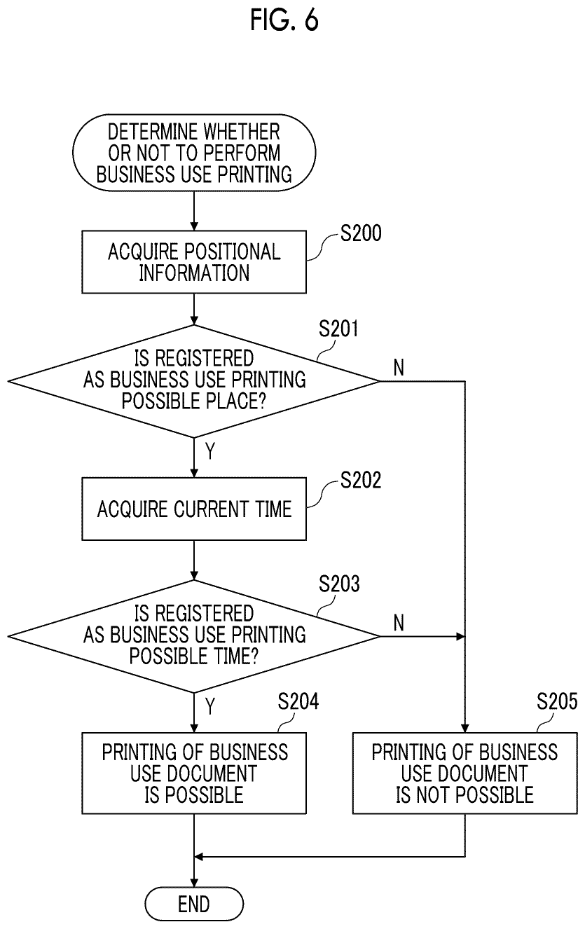

FIG. 6 shows a detailed processing flowchart for determining whether or not it is the environment in which the business use printing is possible in the process of S101 in FIG. 4, that is, in a case where it is distinguished that the account is set for business use. In this process, the determination is performed using the positional information and the time information of the terminal device 12.

First, the processor 12b acquires the positional information of the terminal device 12 (S200). The positional information may be acquired, for example, from the GPS of the terminal device 12. In a case where the terminal device 12 is connected to the network 100, the positional information may be acquired from the connection information.

Next, it is determined whether or not the acquired positional information matches a business use printing possible place registered in advance (S201). In a case where the acquired positional information matches the business use printing possible place registered in advance (YES in S201), next, current time is acquired (S202). The current time may be acquired, for example, from the built-in clock of the terminal device 12. In a case where the terminal device 12 is connected to the network 100, the current time may be acquired via the network 100.

Next, it is determined whether or not the acquired current time matches business use printing possible time registered in advance (S203). In a case where the acquired current time matches business use printing possible time registered in advance (YES in S203), it is determined that printing of the business use document is possible (S204).

On the other hand, in a case where the acquired positional information does not match a business use printing possible place registered in advance (NO in S201) or a case where the acquired current time does not match a business use printing possible time registered in advance (NO in S203), it is determined that document printing is not possible (S205).

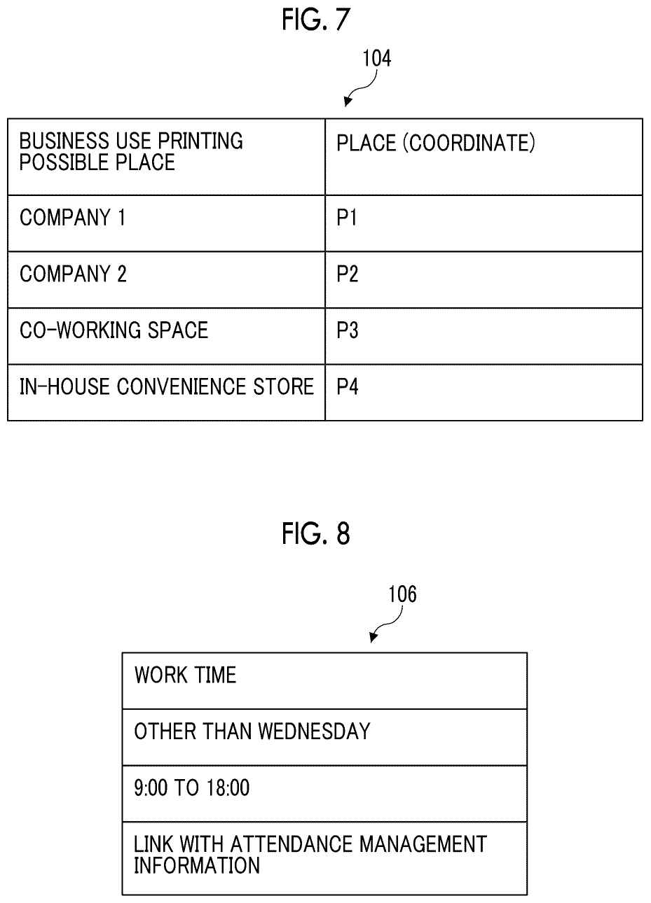

FIG. 7 shows an example of the business use printing possible place registered in advance as a table 104. As the business use printing possible place, place names, such as
company 1
company 2
co-working space, and
in-house convenience store
are registered, and the places (coordinates) P1, P2, P3, and P4 are registered in association with the respective place names. P1, P2, P3, and P4 are GPS coordinates consisting of, for example, (latitude, longitude) but are not limited thereto.

FIG. 8 shows an example of the business use printing possible time registered in advance as a table 106. As the business use printing possible time,
work time
other than Wednesday
9:00 to 18:00
link with attendance management information,
and the like are registered.

The processor 12b executes the process of FIG. 6 on the acquired positional information and the current time with reference to the tables 104 and 106 stored in the storage device 12g.

For example, it is assumed that work time is registered as the business use printing possible time. In a case where the account of the terminal device 12 is for business use, the position of the terminal device 12 matches the GPS coordinates of the company 1 within a certain allowable range, and the current time is within the work time, the processor 12b determines that printing of the business use document is possible and displays the business use document 20 as shown in FIG. 5A. Further, in a case where the account of the terminal device 12 is for business use, the position of the terminal device 12 matches the GPS coordinates of the company 1 within a certain allowable range, and the current time is outside the work time, the processor 12b determines that printing of the document is not possible and displays all the documents as gray display as shown in FIG. 5C. Further, in a case where the account of the terminal device 12 is for private use, the position of the terminal device 12 matches the GPS coordinates of the company 1 within a certain allowable range, and the current time is within the work time, the processor 12b determines that the printing of the document is not possible and displays all the documents as gray display as shown in FIG. 5C. At this time, the processor 12b may display, on the display device 12f, a message, such as
“The account is set up for private use.
Please switch your account to business use in order to print a business use document.”,
to prompt the user to change the account.

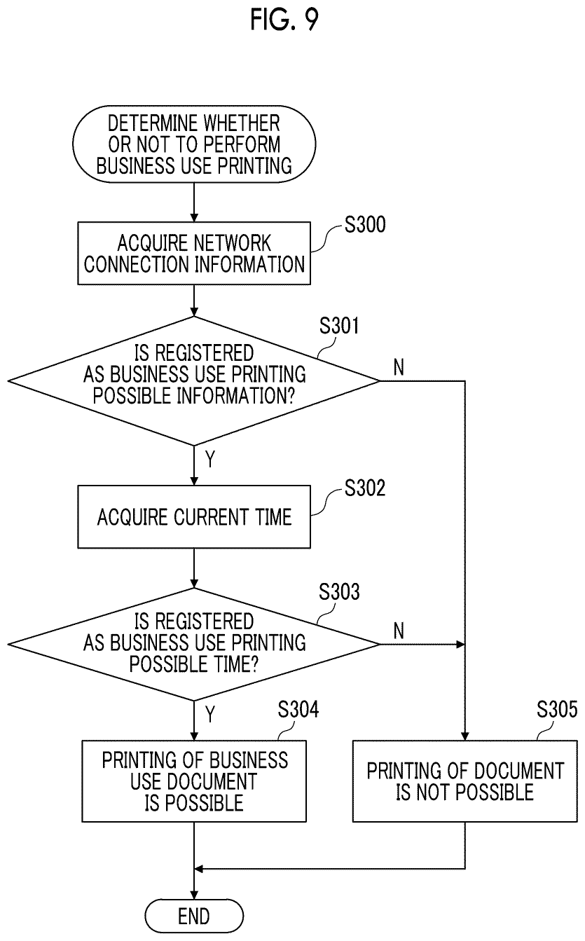

FIG. 9 shows another detailed processing flowchart of determining whether or not it is the environment in which the business use printing is possible in a case where it is distinguished as the process of S101 in FIG. 4, that is, the account is set for business use. In this process, the determination is performed using the network connection information and the time information of the terminal device 12.

First, the processor 12b acquires the network connection information of the terminal device 12 (S300). The network connection information may be acquired, for example, from the communication I/F 12e of the terminal device 12.

Next, it is determined whether or not the acquired network connection information matches the business use printing possible network connection information registered in advance (S301). In a case where the acquired network connection information matches the business use printing possible network connection information registered in advance (YES in S301), next, the current time is acquired (S302). The current time may be acquired, for example, from the built-in clock of the terminal device 12. In a case where the terminal device 12 is connected to the network 100, the current time may be acquired via the network 100.

Next, it is determined whether or not the acquired current time matches the business use printing possible time registered in advance (S303). In a case where the acquired current time matches the business use printing possible time registered in advance (YES in S303), it is determined that printing of the business use document is possible (S304).

On the other hand, in a case where the acquired positional information does not match the business use printing possible network connection information registered in advance (NO in S301) or in a case where the acquired current time does not match the business use printing possible time registered in advance (NO in S303), it is determined that document printing is not possible (S305).

The business use printing possible network connection information indicates a state in which a certain degree of security is ensured for printing a business use document, and may be acquired as, for example, an in-house LAN (intranet) connection. On the other hand, Internet connection may be excluded from the business use printing possible network connection information. It may be determined based on whether or not the network connection information is VPN connection.

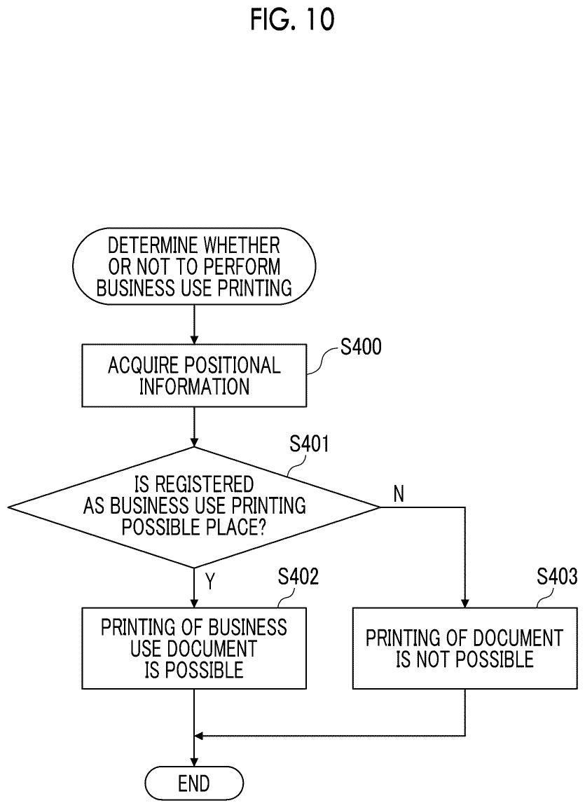

FIG. 10 shows still another detailed processing flowchart of determining whether or not it is the environment in which the business use printing is possible in a case where it is distinguished as the process of S101 in FIG. 4, that is, the account is set for business use. In this process, the determination is performed using only the positional information of the terminal device 12.

First, the processor 12b acquires the positional information of the terminal device 12 (S400). The positional information may be acquired, for example, from the GPS of the terminal device 12. In a case where the terminal device 12 is connected to the network 100, the positional information may be acquired from the connection information.

Next, it is determined whether or not the acquired positional information matches the business use printing possible place registered in advance (S401). In a case where the acquired positional information matches the business use printing possible place registered in advance (YES in S401), it is determined that printing of the business use document is possible (S402).

On the other hand, in a case where the acquired positional information does not match the business use printing possible place registered in advance (NO in S401), it is determined that document printing is not possible (S403).

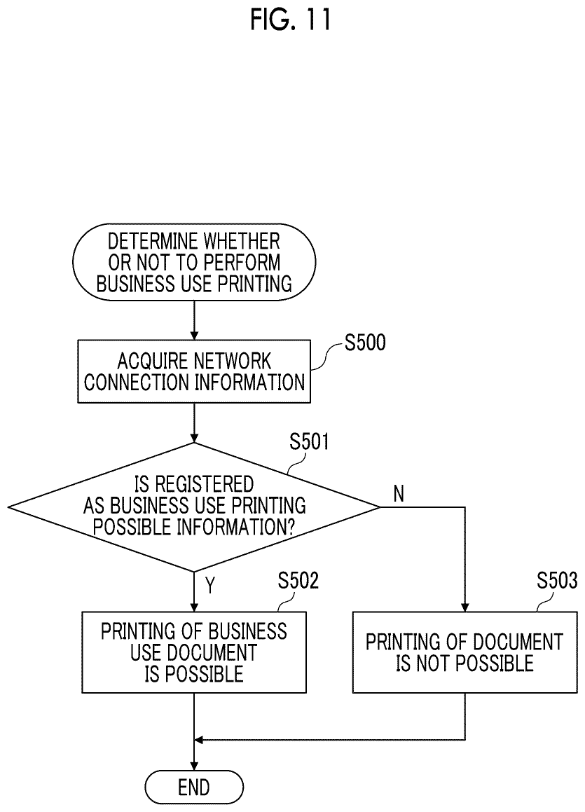

FIG. 11 shows still another detailed processing flowchart of determining whether or not it is the environment in which the business use printing is possible in a case where it is distinguished as the process of S101 in FIG. 4, that is, the account is set for business use. In this process, the determination is performed using only the network connection information of the terminal device 12.

First, the processor 12b acquires the network connection information of the terminal device 12 (S500). The connection information may be acquired, for example, from the communication I/F 12e of the terminal device 12.

Next, it is determined whether or not the acquired network connection information matches the business use printing possible information registered in advance (S501). In a case where the acquired network connection information matches the business use printing possible information registered in advance (YES in S501), it is determined that printing of the business use document is possible (S502).

On the other hand, in a case where the acquired network connection information does not match the business use printing possible information registered in advance (NO in S501), it is determined that document printing is not possible (S503).

As described above, in the present exemplary embodiment, it is determined whether or not to print a document according to at least any of the current account type set for the terminal device 12, the positional information of the terminal device 12, the time information, and the network connection information, and a determination result is output to the display device 12f. Therefore, the user may give a printing instruction for an appropriate document to the printing device 10 without being particularly aware of the type of account of the current account.

The positional information, the time information, and the network connection information may be randomly combined. Examples of the combinations are as follows.
positional information only
time information only
network connection information only
positional information and time information
positional information and network connection information
time information and network connection information
positional information, time information, and network connection information

The combinations may be set by default in a program installed in the terminal device 12, or may be configured to be appropriately selected by a user, a manager, or the like.

Next, distinguishment of whether the various documents stored in the storage device 12g are a business use document or a private use document will be described.

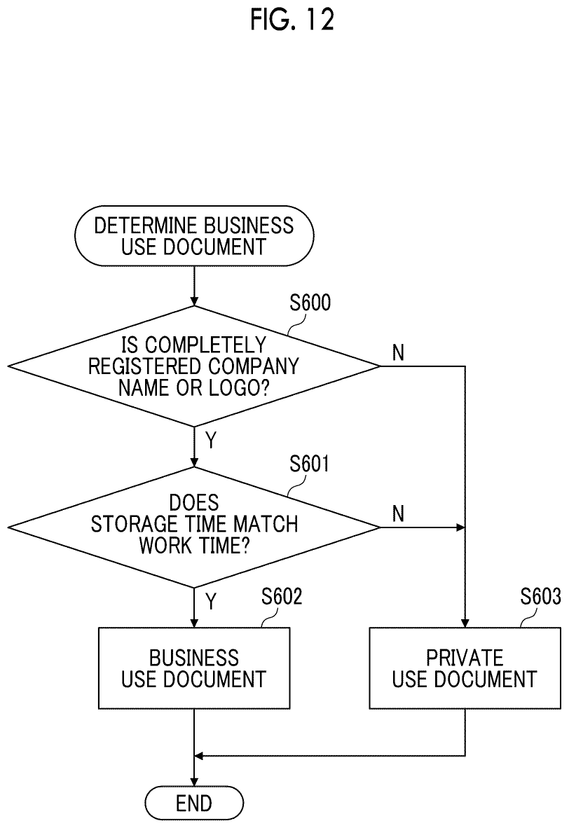

FIG. 12 shows an exemplary processing flowchart of determining whether or not it is a business use document.

The processor 12b determines whether or not a company name or a logo, which is completely registered in advance, is included in a document (S600).

In a case where the company name or the logo is included in the document, it is next determined whether or not time at which the document is stored in the storage device 12g matches work time registered in advance (S601). In a case where the company name or the logo is included in the document and the storage time matches the work time, it is determined that the document is the business use document (S602). Examples of the business use document include a presentation document containing a company logo, a document containing a company name in a file name, an invoice containing the company name, and a photograph of a whiteboard taken during work time.

On the other hand, in a case where the company name or the logo, which is completely registered, is not included in the document or the storage time does not match the work time, it is determined that the document is not a business use document but a private use document (S603). Examples of a private use document include photographs of family members or pets, documents including shopping memos, documents recorded with daily blood pressure measurements, documents acquired from websites on holidays, and the like.

After determining whether the document is a business use document or a private use document, the processor 12b stores a determination result in association with the document in the storage device 12g. In a case where the determination result is stored, current time is also stored. In a case where the process of FIG. 12 is executed with the printing instruction as a trigger, the stored current time can be regarded as the time of the printing instruction.

In the process of FIG. 12, it is determined that the document is a business use document in a case where the company name or the logo is included and the storage time matches the work time. Meanwhile, it may be determined that the document is a business use document in a case where the company name or the logo is included or the storage time matches the work time.

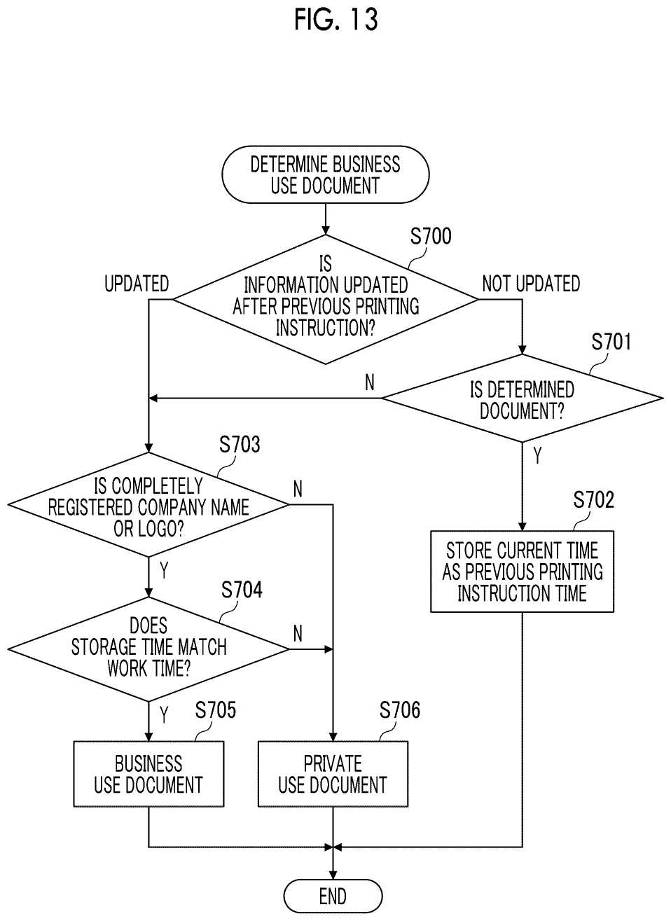

FIG. 13 shows another processing flowchart of determining whether or not it is a business use document. In this process, in a case where there is a fact that a printing instruction is given before, the determination is skipped by utilizing the fact, so that the processing efficiency is improved.

In FIG. 13, the processor 12b determines whether or not the information is updated after a previous printing instruction is given (S700). Here, “update of information” specifically indicates update of document information.

In a case where the information is not updated, next, it is determined whether or not the document stored in the storage device 12g is a document which is already determined whether or not to be a business use document (S701). In a case of the determined document (YES in S701), the determination at the time of the previous printing instruction, that is, the determination of whether or not to be a business use document is kept without change, and the current time is stored as previous printing instruction time (S702). At the time of a next printing instruction, information at the time of a current printing instruction is used.

On the other hand, in a case where the information is updated or in a case of a document which is not determined whether or not to be a business use document (NO in S701), the processing flowchart shown in FIG. 12 is executed to determine whether or not to be a business use document again (S703 to S706).

Hereinafter, a more specific description will be given.

As shown in the processing flowchart of FIG. 6, it is assumed that, in a case where the account of the terminal device 12 is set as the business use account, whether or not to print the business use document is determined according to the positional information and the time information.

It is assumed that the user operates the terminal device 12 to input a printing instruction at certain time T1. It is assumed that the processor 12b determines that a document a and a document b is printable as a business use document and is not printable as a private use document, respectively, according to the positional information and the time information. That is,
<Time T1>
document a=business use document
document b=private use document.

A case may be exemplified where the document a includes the company name and the storage time is within the work time, and the document b does not include the company name and the storage time is also outside the work time.

Next, it is assumed that the user operates the terminal device 12 again at time T2 after the time T1 to input the printing instruction. The processor 12b determines whether or not the information has been updated after the previous time T1. In a case where both the document a and the document b are not updated, the determination at the time T1 is kept without change. That is, a fact
<Time T2>
document a=printable as a business use document
document b=not printable as a private use document
is kept without change.

On the other hand, it is assumed that the document a is updated between the time T1 and the time T2. For example, a case may be exemplified where the user reads out the document a between the time T1 and the time T2, edits the document a, and stores the document a in the storage device 12g again. At this time, the processor 12b assumes that the information is updated, repeats the processes of S703 and subsequent steps, and determines whether or not the document a is a business use document again.

Since the document b is not updated, the determination at the time T1 is kept without change.

In the processes of FIG. 12 and FIG. 13, the company name and the logo included in the document are used, but a specific text string or image other than the company name and the logo may be registered in advance as a keyword (or a key image), and it may be determined whether or not to be the business use document by searching the document for the completely registered keyword. A technique for extracting and searching for a keyword from a document is known, and for example, a technique disclosed in JP2021-60732A may be used.

Although the exemplary embodiment of the present invention has been described above, the present invention is not limited to the above-described exemplary embodiment, and various modifications can be made.

For example, in the present exemplary embodiment, a business use account and a private use account are exemplified as a plurality of accounts, but the number of business use accounts is not limited to one and may be two or more. In a case where there are two or more business use accounts, the positional information, the time information, and the network connection information registered in advance in order to determine whether or not to print the business use documents may be set for the respective accounts. For example, there are a first business account and a second business account as business use accounts, the position of a company A is registered as business use printing possible positional information for the first business account, and the position of a company B is registered as the business use printing possible positional information for the second business account. In addition, a specific day is registered as business use printing possible time information for the first business account, and a day other than the specific day is registered as the business use printing possible time information for the second business account.

### Supplementary Notes

(((1)))

A program causing a processor to execute a process comprising:
distinguishing a user's account among a plurality of accounts; and
outputting after determining whether or not to print a document based on a result of the distinguishment and positional information obtained in a case where the user instructs printing.
(((2)))

The program according to (((1))),
wherein the outputting includes outputting after determining that printing of a business use document is possible in a case where the distinguished account is for business use and the positional information matches a position registered in advance as being possible to perform business use printing.
(((3)))

The program according to (((2))),
wherein the outputting includes displaying the business use document on a display device to be selectable and not displaying a private use document to be selectable.
(((4)))

The program according to any one of (((1))) to (((3))),
wherein the outputting includes outputting after determining that printing of a private use document is possible in a case where the distinguished account is for private use and the positional information does not match a position registered in advance as being possible to perform business use printing.
(((5)))

The program according to (((4))),
wherein the outputting includes displaying the private use document on a display device to be selectable and not displaying a business use document to be selectable.
(((6)))

A program causing a processor to execute a process comprising:
distinguishing a user's account among a plurality of accounts; and
outputting after determining whether or not to print a document based on a result of the distinguishment and time information obtained in a case where the user instructs printing.
(((7)))

The program according to (((6))),
wherein the outputting includes outputting after determining that printing of a business use document is possible in a case where the distinguished account is for business use and the time information matches time registered in advance as work time.
(((8)))

The program according to (((6))) or (((7))),
wherein the outputting includes outputting after determining that printing of a private use document is possible in a case where the distinguished account is for private use and the time information does not match time registered in advance as work time.
(((9)))

A program causing a processor to execute a process comprising:
distinguishing a user's account among a plurality of accounts; and
outputting after determining whether or not to print a document based on a result of the distinguishment and the network connection information obtained in a case where the user instructs printing.
(((10)))

The program according to (((9))),
wherein the outputting includes outputting after determining that printing of a business use document is possible in a case where the distinguished account is for business use and the network connection information matches a network type in which business use printing is possible.
(((11)))

The program according to (((9))) or (((10))),
wherein the outputting includes outputting after determining that printing of a private use document is possible in a case where the distinguished account is for private use and the network connection information does not match the network type in which business use printing is possible.
(((12)))

The program according to any one of (((1))) to (((11))),
wherein the outputting includes further outputting after determining whether or not to print the document based on the result of the distinguishment, the positional information, and at least any of time information and network connection information obtained in a case where the user instructs printing.
(((13)))

The program according to (((12))),
wherein the outputting includes outputting after determining that printing of a business use document is possible in a case where the distinguished account is for business use, the positional information matches a position registered in advance as being possible to perform business use printing, and the time information matches time registered in advance as work time.
(((14)))

The program according to (((12))) or (((13))),
wherein the outputting includes outputting after determining that printing of a private use document is possible in a case where the distinguished account is for private use, the positional information does not match a position registered in advance as being possible to perform business use printing, and the time information does not match time registered in advance as work time.
(((15)))

An information processing system comprising:
a processor; and
a display device,
wherein the processor is configured to:
   distinguish a user's account among a plurality of accounts; and
   determining whether or not to print a document and outputting a result of determination to the display device based on a result of the distinguishment and positional information obtained in a case where the user instructs printing.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a processor to execute a process comprising:
distinguishing a user's account among a plurality of accounts; and
outputting after determining whether or not to print a document based on a result of the distinguishment and positional information obtained in a case where the user instructs printing.

2. The non-transitory computer readable medium storing a program according to claim 1,
wherein the outputting includes outputting after determining that printing of a business use document is possible in a case where the distinguished account is for business use and the positional information matches a position registered in advance as being possible to perform business use printing.

3. The non-transitory computer readable medium storing a program according to claim 2,
wherein the outputting includes displaying the business use document on a display device to be selectable and not displaying a private use document to be selectable.

4. The non-transitory computer readable medium storing a program according to claim 1,
wherein the outputting includes outputting after determining that printing of a private use document is possible in a case where the distinguished account is for private use and the positional information does not match a position registered in advance as being possible to perform business use printing.

5. The non-transitory computer readable medium storing a program according to claim 4,
wherein the outputting includes displaying the private use document on a display device to be selectable and not displaying a business use document to be selectable.

6. A non-transitory computer readable medium storing a program causing a processor to execute a process comprising:
distinguishing a user's account among a plurality of accounts; and
outputting after determining whether or not to print a document based on a result of the distinguishment and time information obtained in a case where the user instructs printing.

7. The non-transitory computer readable medium storing a program according to claim 6,
wherein the outputting includes outputting after determining that printing of a business use document is possible in a case where the distinguished account is for business use and the time information matches time registered in advance as work time.

8. The non-transitory computer readable medium storing a program according to claim 6,
wherein the outputting includes outputting after determining that printing of a private use document is possible in a case where the distinguished account is for private use and the time information does not match time registered in advance as work time.

9. The non-transitory computer readable medium storing a program according to claim 1,
wherein the outputting includes further outputting after determining whether or not to print the document based on the result of the distinguishment, the positional information, and at least any of time information and network connection information obtained in a case where the user instructs printing.

10. The non-transitory computer readable medium storing a program according to claim 9,
wherein the outputting includes outputting after determining that printing of a business use document is possible in a case where the distinguished account is for business use, the positional information matches a position registered in advance as being possible to perform business use printing, and the time information matches time registered in advance as work time.

11. The non-transitory computer readable medium storing a program according to claim 9,
wherein the outputting includes outputting after determining that printing of a private use document is possible in a case where the distinguished account is for private use, the positional information does not match a position registered in advance as being possible to perform business use printing, and the time information does not match time registered in advance as work time.
